(19) United States
(12) Patent Application Publication
(10) Pub. No.: US 2021/0011998 A1
(43) Pub. Date: Jan. 14, 2021

(54) ABNORMAL ACTIVITY DETECTION

(71) Applicant: International Business Machines Corporation, Armonk, NY (US)

(72) Inventors: David C. Reed, Tucson, AZ (US); Franklin E. McCune, Tucson, AZ (US); Philip R. Chauvet, Tucson, AZ (US); Thomas C. Reed, Tucson, AZ (US)

(73) Assignee: International Business Machines Corporation, Armonk, NY (US)

(21) Appl. No.: 16/507,736

(22) Filed: Jul. 10, 2019

(51) Int. Cl. G06F 21/55; G06F 21/56

(52) U.S. Cl. CPC G06F 21/552; G06F 21/566; G06F 21/565

(57) ABSTRACT

A method for detecting abnormal activity on a computing system is disclosed. In one embodiment, such a method includes observing, over a period of time, activity occurring on a computing system. The method establishes, for the computing system based on the observations, a normal range associated with the activity. The method further monitors the computing system for the activity and documents activity on the computing system that falls outside the normal range. In certain embodiments, when activity is detected on the computing system that falls outside the normal range, the method gathers or compiles additional information about the activity, notifies a user, and/or generates a report that describes the abnormal activity and events surrounding the abnormal activity. A corresponding system and computer program product are also disclosed.

### BACKGROUND

### Field of the Invention

This invention relates to systems and methods for detecting abnormal activity in a computing system.

### Background of the Invention

In many types of computing systems, such as host systems and/or storage systems, various types of events and activity may occur on a regular and/or recurring basis. In some cases, these events and activity may include errors or other issues that, while possibly indicating some problem, are not critical to the computing system and are not likely to affect the overall performance or mission of the computing system. In certain cases, these errors or other issues may be considered “normal” on a computing system or within a normal range of activity on the computing system.

As an analogy, a check-engine light in an automobile may indicate some underlying issue in the automobile. This issue may not be critical to the overall function or health of the automobile, nor may it prevent the automobile from performing its primary function or objective of safely transporting people or goods from one location to another. Most if not all of the normal operations of the automobile may continue unimpeded by the underlying issue.

In the same way, a computing system may exhibit underlying issues such as bugs, error messages, abnormal terminations, or the like that, while possibly distracting or annoying, may be recovered from or addressed without preventing the computing system from performing its primary functions. The underlying issues may be the result of the computing system executing old code levels, operating hardware with slight or insignificant incompatibilities, communicating with external systems that are exhibiting problems or incompatibilities, and/or the like.

In view of the foregoing, what are needed are systems and methods to detect, within a computing system, events and activity that may occur on a regular and/or recurring basis. Further needed are systems and methods to determine which activity may be considered “normal” on a computing system or within a normal range of activity on the computing system. Yet further needed are systems and methods to determine when events or activity fall outside of what is considered a normal range of activity.

### SUMMARY

The invention has been developed in response to the present state of the art and, in particular, in response to the problems and needs in the art that have not yet been fully solved by currently available systems and methods. Accordingly, embodiments of the invention have been developed to detect abnormal activity occurring on a computing system. The features and advantages of the invention will become more fully apparent from the following description and appended claims, or may be learned by practice of the invention as set forth hereinafter.

Consistent with the foregoing, a method for detecting abnormal activity on a computing system is disclosed. In one embodiment, such a method includes observing, over a period of time, activity occurring on a computing system. The method establishes, for the computing system based on the observations, a normal range associated with the activity. The method further monitors the computing system for the activity and documents activity on the computing system that falls outside the normal range. In certain embodiments, when activity is detected on the computing system that falls outside the normal range, the method gathers or compiles additional information about the activity, notifies a user, and/or generates a report that describes the abnormal activity and events surrounding the abnormal activity.

A corresponding system and computer program product are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 is a high-level block diagram showing one example of a network environment in which systems and methods in accordance with the invention may be implemented;

FIG. 2 is a high-level block diagram showing one embodiment of a storage system for use in the network environment of FIG. 1;

FIG. 3 is a high-level block diagram showing an abnormal activity detection module in accordance with the invention;

FIG. 4 is a timeline showing a learning period and a monitoring period;

FIG. 5 is a timeline showing the detection of activity that falls outside a normal range;

FIG. 6 is a timeline also showing the detection of activity that falls outside a normal range; and

FIG. 7 is a flow diagram showing one embodiment of a method for detecting abnormal activity occurring on a computing system.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

The present invention may be embodied as a system, method, and/or computer program product. The computer program product may include a computer readable storage medium (or media) having computer readable program instructions thereon for causing a processor to carry out aspects of the present invention.

The computer readable storage medium may be a tangible device that can retain and store instructions for use by an instruction execution device. The computer readable storage medium may be, for example, but is not limited to, an electronic storage system, a magnetic storage system, an optical storage system, an electromagnetic storage system, a semiconductor storage system, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage system via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages.

The computer readable program instructions may execute entirely on a user's computer, partly on a user's computer, as a stand-alone software package, partly on a user's computer and partly on a remote computer, or entirely on a remote computer or server. In the latter scenario, a remote computer may be connected to a user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention may be described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, may be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

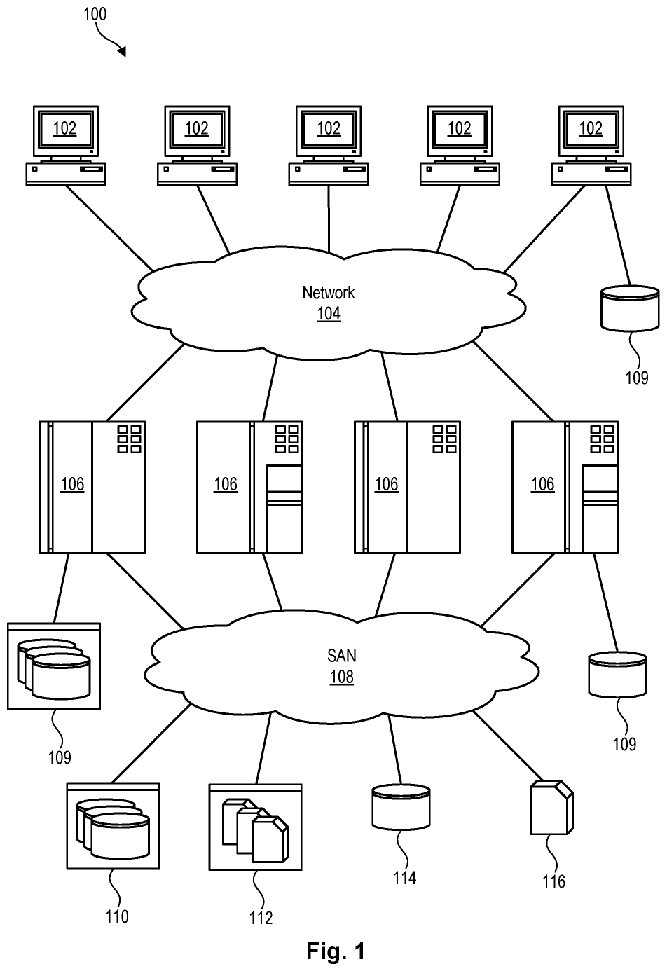

Referring to FIG. 1, one example of a network environment 100 is illustrated. The network environment 100 is presented to show one example of an environment where systems and methods in accordance with the invention may be implemented. The network environment 100 is presented by way of example and not limitation. Indeed, the systems and methods disclosed herein may be applicable to a wide variety of different network environments in addition to the network environment 100 shown.

As shown, the network environment 100 includes one or more computers 102, 106 interconnected by a network 104. The network 104 may include, for example, a local-area-network (LAN) 104, a wide-area-network (WAN) 104, the Internet 104, an intranet 104, or the like. In certain embodiments, the computers 102, 106 may include both client computers 102 and server computers 106 (also referred to herein as “hosts” 106 or “host systems” 106). In general, the client computers 102 initiate communication sessions, whereas the server computers 106 wait for and respond to requests from the client computers 102. In certain embodiments, the computers 102 and/or servers 106 may connect to one or more internal or external direct-attached storage systems 109 (e.g., arrays of hard-storage drives, solid-state drives, tape drives, etc.). These computers 102, 106 and direct-attached storage systems 109 may communicate using protocols such as ATA, SATA, SCSI, SAS, Fibre Channel, or the like.

The network environment 100 may, in certain embodiments, include a storage network 108 behind the servers 106, such as a storage-area-network (SAN) 108 or a LAN 108 (e.g., when using network-attached storage). This network 108 may connect the servers 106 to one or more storage systems, such as arrays 110 of hard-disk drives or solid-state drives, tape libraries 112, individual hard-disk drives 114 or solid-state drives 114, tape drives 116, CD-ROM libraries, or the like. To access a storage system 110, 112, 114, 116, a host system 106 may communicate over physical connections from one or more ports on the host 106 to one or more ports on the storage system 110, 112, 114, 116. A connection may be through a switch, fabric, direct connection, or the like. In certain embodiments, the servers 106 and storage systems 110, 112, 114, 116 may communicate using a networking standard or protocol such as Fibre Channel (FC) or iSCSI.

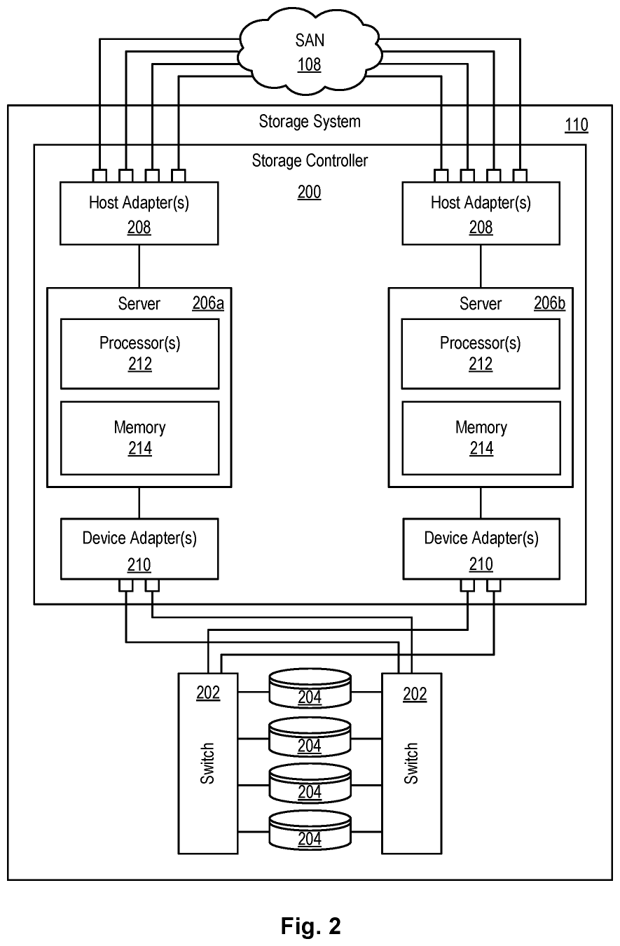

Referring to FIG. 2, one example of a storage system 110 containing an array of hard-disk drives 204 and/or solid-state drives 204 is illustrated. As shown, the storage system 110 includes a storage controller 200, one or more switches 202, and one or more storage drives 204, such as hard-disk drives 204 and/or solid-state drives 204 (e.g., flash-memory-based drives 204). The storage controller 200 may enable one or more host systems 106 (e.g., open system and/or mainframe servers 106 running operating systems such z/OS, zVM, or the like) to access data in the one or more storage drives 204.

In selected embodiments, the storage controller 200 includes one or more servers 206a, 206b. The storage controller 200 may also include host adapters 208 and device adapters 210 to connect the storage controller 200 to host devices 106 and storage drives 204, respectively. Multiple servers 206a, 206b may provide redundancy to ensure that data is always available to connected host systems 106. Thus, when one server 206a fails, the other server 206b may pick up the I/O load of the failed server 206a to ensure that I/O is able to continue between the host systems 106 and the storage drives 204. This process may be referred to as a “failover.”

In selected embodiments, each server 206 may include one or more processors 212 and memory 214. The memory 214 may include volatile memory (e.g., RAM) as well as non-volatile memory (e.g., ROM, EPROM, EEPROM, hard disks, flash memory, etc.). The volatile and non-volatile memory may, in certain embodiments, store software modules that run on the processor(s) 212 and are used to access data in the storage drives 204. These software modules may manage all read and write requests to logical volumes 322 in the storage drives 204.

One example of a storage system 110 having an architecture similar to that illustrated in FIG. 2 is the IBM DS8000™ enterprise storage system. The DS8000™ is a high-performance, high-capacity storage controller providing disk and solid-state storage that is designed to support continuous operations. Nevertheless, the techniques disclosed herein are not limited to the IBM DS8000™ enterprise storage system 110, but may be implemented in any comparable or analogous storage system 110, regardless of the manufacturer, product name, or components or component names associated with the system 110. Any storage system that could benefit from one or more embodiments of the invention is deemed to fall within the scope of the invention. Thus, the IBM DS8000™ is presented only by way of example and not limitation.

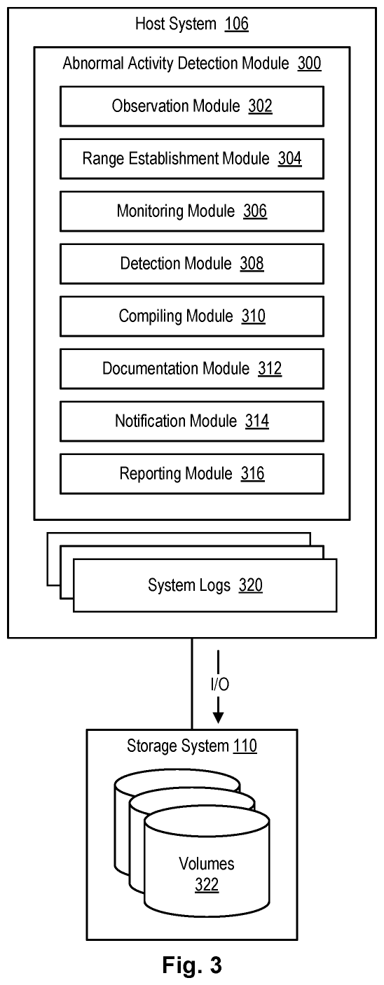

Referring to FIG. 3, as previously mentioned, in many types of computing systems, such as host systems 106 and/or storage systems 109, 110, 112, 114, 116, various types of events and activity may occur on a regular and/or recurring basis. In some cases, these events and activity may include errors or other issues that, while possibly indicating some problem on the computing system, are not critical to the computing system and will not affect the overall performance or mission of the computing system. In certain cases, these errors or other issues may be considered “normal” on a computing system, or within a normal range of activity on the computing system.

For example, a computing system may exhibit underlying issues such as bugs, error messages, abnormal terminations, or the like that, while possibly distracting or annoying to user, may be recovered from or addressed without preventing the computing system from performing its primary functions. The underlying issues may be the result of the computing system executing old code levels, operating hardware with slight or insignificant incompatibilities, communicating with external systems exhibiting problems or incompatibilities, and/or the like.

In view of the foregoing, systems and methods are needed to detect, within a computing system, events and activity that may occur on a regular and/or recurring basis. Further needed are systems and methods to determine which activity may be considered “normal” on a computing system, or within a normal range of activity on the computing system. Yet further needed are systems and methods to determine when events or activity fall outside of what is considered a normal range of activity.

In certain embodiments, in order to achieve the objectives set forth above, a computing system may be configured with an abnormal activity detection module 300 in accordance with the invention. In the illustrated embodiment, the abnormal activity detection module 300 is shown within a host system 106, although it is not limited to implementation within a host system 106. The abnormal activity detection module 300 may include various sub-modules to provide various features and functions. The abnormal activity detection module 300 and associated sub-modules may be implemented in hardware, software, firmware, or combinations thereof. The abnormal activity detection module 300 and associated sub-modules are presented by way of example and not limitation. More or fewer sub-modules may be provided in different embodiments. For example, the functionality of some sub-modules may be combined into a single or smaller number of sub-modules, or the functionality of a single sub-module may be distributed across several sub-modules. As shown, the abnormal activity detection module 300 includes one or more of an observation module 302, range establishment module 304, monitoring module 306, detection module 308, compiling module 310, documentation module 312, notification module 314, and reporting module 316.

The observation module 302 may be configured to observe, over a period of time (e.g., one month, ninety days, etc.), activity that occurs on a computing system, such as the illustrated host system 106 and/or storage system 110. In certain embodiments, the period of time may be selected to enable the observation module 302 to sufficiently learn activity that normally occurs on the computing system. During the period of time, the observation module 302 may observe activity such as I/O amounts, I/O performance, error conditions, job volumes, job durations, job start/end events, resource usage (e.g., memory usage), or the like, as well as the times, days, and/or frequency that each of the activities occur. In making the observations, the observation module 302 may, in certain embodiments, analyze system logs 320 such as LOGREC logs, RMF/SMF data logs, job logs, and the like. In certain embodiments, the observation module 302 is configured to analyze system logs 320 during periods of low system activity in order to minimize any impact on the computing system. To reduce demands on the computing system, the observation module 302 may, in certain embodiments, enable a user to restrict the amounts or types of activity that are observed.

From the activity observed by the observation module 302, the range establishment module 304 may establish a normal range for the activity. For example, the range establishment module 304 may establish a normal range for observed I/O amounts, I/O performance, error conditions, job volumes, job durations, job start/end events, resource usage, or the like. The range establishment module 304 may also establish the times, days, and/or frequency in which these different activities normally occur. As an example, the range establishment module 304 may construct a high-level picture of what jobs normally run during certain periods of time, the amount of resources the jobs use, normal completion times for the jobs, and/or common errors or messages that occur during these periods of time.

Certain activity, which may be considered rare or abnormal on some computing systems, may be considered normal or routine on other computing systems. The range establishment module 304 may, in certain embodiments, classify certain activity (errors, etc.) as being normal or within a range of normal activities on a computing system even though it might be considered abnormal or unusual on another computing system.

Once normal ranges are established, the monitoring module 306 may monitor the computing system (e.g., the host system 106 and/or the storage system 110) for activity. The detection module 308 may detect when activity falls outside the normal ranges. For example, the detection module 308 may detect when I/O amounts, I/O performance, error conditions, job volumes, job durations, job start/end events, memory usage, or the like, fall outside normal ranges. The detection module 308 may also, in certain embodiments, detect when such activity occurs at times, days, and/or frequencies outside of what is normally observed.

When activity is detected that falls outside normal ranges, the compiling module 310 may compile information associated with the detected abnormal activity. In certain embodiments, this may include gathering data from various system logs 320. Information gathered may include, for example, hardware devices, job names, data sets (i.e., named collections of records), logical partitions (LPARS), times/dates, sources, or the like that are associated with or have some connection to the abnormal activity. In certain embodiments, when abnormal activity is detected, the compiling module 310 may issue system queries to system logs 320 or data stores to gather additional information associated with the abnormal activity.

Once the compiling module 310 has gathered and/or compiled information associated with the abnormal activity, the documentation module 312 may document the abnormal activity. This may include documenting events, systems states, settings, and the like, associated with or surrounding the abnormal activity. In certain embodiments, when abnormal activity is detected, a notification module 314 may notify a user (e.g., system administrator) using a message such as an email or text message. In certain embodiments, a reporting module 316 may generate a report that details abnormal activity and events, systems states, settings, and the like, associated with or surrounding the abnormal activity. This report may be formatted to facilitate quick and easy review by a user. Any or all of the information gathered by the compiling module 310 may be included in the report.

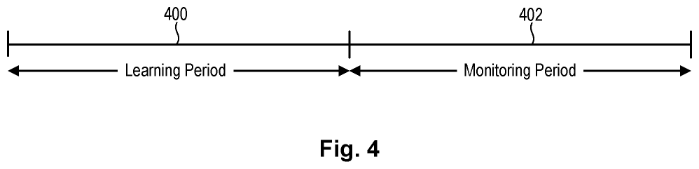

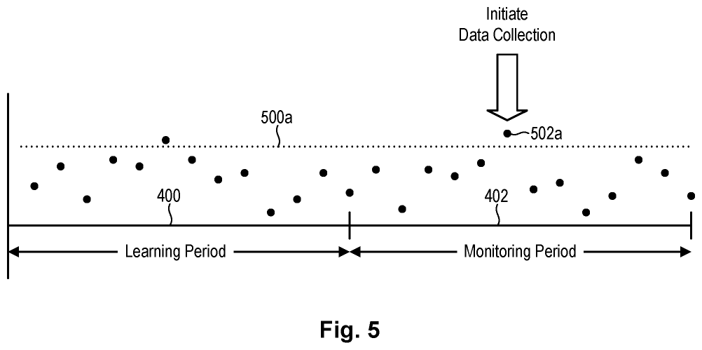

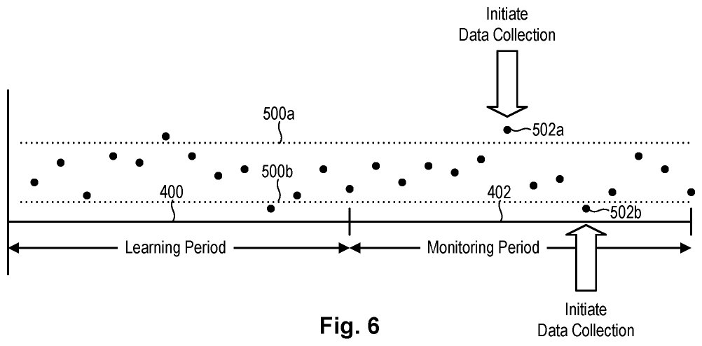

Referring to FIG. 4, as shown, the abnormal activity detection module 300 may be characterized by a learning period 400 and a monitoring period 402. During the learning period 400, the abnormal activity detection module 300 learns activity that normally occurs on a computing system, including activity that might be considered abnormal on other computing systems. During the learning period 400, the abnormal activity detection module 300 establishes normal ranges for the observed activity. The abnormal activity detection module 300 may then initiate the monitoring period 402 wherein activity is monitored on the computing system. During the monitoring period 402, the abnormal activity detection module 300 may look for activity that falls outside the normal ranges. For example, as shown in FIG. 5, if, during the monitoring period 402, the abnormal activity detection module 300 detects an event 502a that is above a normal range (in this example above an upper threshold 500a), the abnormal activity detection module 300 may initiate collection of data associated with the event 502a. Similarly, as shown in FIG. 6, if, during the monitoring period 402, the abnormal activity detection module 300 detects an event 502b that is below a normal range (in this example below a lower threshold 500b), the abnormal activity detection module 300 may also initiate collection of data associated with the event 502b.

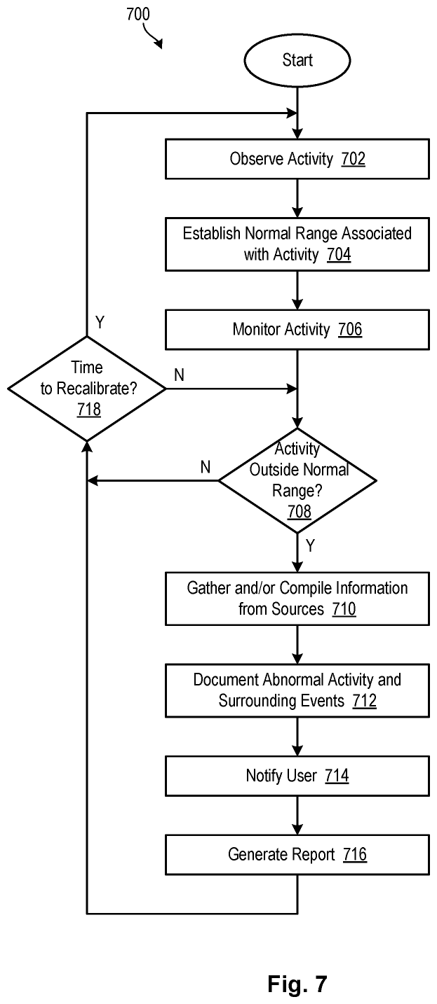

Referring to FIG. 7, one embodiment a method 700 for detecting abnormal activity occurring on a computing system is illustrated. Such a method 700 may, in certain embodiments, be executed by an abnormal activity detection module 300 in accordance with the invention. As shown, the method 700 initially observes 702 activity occurring on a computing system. This activity may include, for example, I/O amounts, I/O performance, error conditions, job volumes, job durations, job start/end events, resource usage, and/or the like, as well as times, days, and/or frequencies in which the activities are observed. In certain embodiments, the method 700 observes 702 activities occurring on the computing system by analyzing system logs 320.

The method 700 then establishes 704 normal ranges with respect to the observed activity. For example, the method 700 may establish 704 normal ranges with respect to I/O amounts, I/O performance, error conditions, job volumes, job durations, job start/end events, resource usage, and/or the like, as well as times, days, and/or frequencies for the activities that are observed. In certain embodiments, the steps 702, 704 are performed during the learning period 400 previously described in order to acquire information about normal or customary activities on a computing system.

Once the learning period 400 has completed, the method 700 initiates a monitoring period 402. During the monitoring period 402, the method 700 monitors 706 activity that occurs on the computing system. During this monitoring period 402, the method 700 determines 708 whether activity that occurs on the computing system falls outside a normal range. If so, the method 700 gathers 710 and/or compiles 710 information from sources such as system logs 320 to provide information on causes or sources of the abnormal activity. The method 700 documents 712 the abnormal activity and events surrounding or associated with the abnormal activity. In certain embodiments, the method 700 notifies 714 a user of the abnormal activity and/or generates 716 a report documenting the abnormal activity. The method 700 then returns to step 708 to determine whether any activity on the computing system falls outside a normal range.

Periodically, such as every interval (e.g., every year) or after configuration changes have occurred on a computing system, the method 700 recalibrates 718. That is, the method 700 repeats the learning period 400 to observe what is considered normal on the computing system. This may be performed because, over time and with configuration changes (e.g., hardware or code level updates) to the computing system, what is considered normal activity on a computing system may change. Certain events that were formerly considered normal may no longer be considered normal and vice versa.

Embodiments of the invention may be used in various use cases as set forth below. For example, embodiments of the invention may analyze LOGREC records to determine what type of activity is normal on a system (e.g., host system 106 and/or storage system 110). LOGREC data may contain records that are created when hardware or software errors occur. However, as previously explained, some types of abnormal events may be common on some systems. What may be common on one system may be quite rare on another system. LOGREC data summarizes events and activity that have occurred on a system over a period of time such as a twenty-four hour window. Over a ninety day period, threshold values describing what is considered normal may be established.

Embodiments of the invention may also analyze system logs 320. The volume of data in system logs 320 during a twenty-four hour window may be quite large. Thus, in certain embodiments, embodiments of the invention may enable a user to specify what types of activity to analyze, such as ABENDS, specific return codes, attributes related to specific jobs, or the like. RMF/SMF data may also contain valuable performance data such as I/O-related statistics. Using this data, an expected range of values (i.e., normal ranges) may be established for devices (e.g., storage drives 204). Also, performance attributes related to specific jobs may be established such as elapsed time, CPU time, EXCP count, and other attributes. Data from specific job logs may also be analyzed for specific return codes to establish what is expected and what is unusual.

After data is gathered from various sources, such as those set forth above, the data may be merged based on time and date into intervals such as fifteen minute intervals. Each interval may provide a summary of what occurred during the interval that was outside of normal ranges. Specific events may be listed along with information indicating where more details are located. For example, if a high volume of out-of-memory dumps occurred during an interval, the number of dumps along with their times may be listed. The first dump that occurred during that interval may be of primary interest. Important pieces of information, such as the first time a specific event occurred, may be merged into a daily summary view. This may enable a user to determine the first time a specific event occurred during a twenty-four hour window. This data may be written to a data set that stores a report for each day. The user may, in certain embodiments, specify how many days of reports to keep or how much data to retain, or specify permanent retention that may cause the data to be archived.

Another use case involves several jobs that take longer than normal to complete. Using historical data that is collected for the jobs, the historical data may be analyzed to determine what attributes of the jobs are outside of normal. For example, total CPU usage may be slightly higher than normal, while an elapsed time and Execute Channel Program (EXCP) count indicating additional I/O may be much higher than normal or I/O response times may be outside of normal. This may indicate that more data than normal is being processed by a job, or perhaps there are issues with channels or storage hardware. This may then lead to an analysis of RMF data to determine if any statistics for involved devices (e.g., storage drives 204) are outside of their expected values. If these values are normal, then the analysis may focus on the amount of data processed. A report documenting the analysis and recommended next steps may then be generated.

When an impactful widespread error event occurs, a report may be generated that focuses on events that were unusual and led up to the widespread error event in question. The report may highlight values that are outside of an expected range along with an indication or metric of what is considered to be normal. This information may be reviewed by a user for products the user has in his or her environment. The user may also review this information on a daily basis to determine what events are outside of what is expected.

The flowcharts and/or block diagrams in the Figures illustrate the architecture, functionality, and operation of possible implementations of systems, methods, and computer-usable media according to various embodiments of the present invention. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

1. A method for detecting abnormal activity occurring on a computing system, the method comprising:
observing, by a at least one processor over a period of time, activity occurring on a computing system;
establishing, for the computing system based on the observations, a normal range associated with the activity that is observed on the computing system;
monitoring, by the at least one processor, the computing system for the activity; and
documenting, by the at least one processor, the activity on the computing system that falls outside the normal range.

2. The method of claim 1, further comprising notifying a user when the activity on the computing system falls outside the normal range.

3. The method of claim 1, wherein observing the activity comprises observing systems logs for the activity.

4. The method of claim 1, further comprising, when activity is detected on the computing system which falls outside the normal range, gathering additional information about the activity.

5. The method of claim 1, further comprising, when activity is detected on the computing system which falls outside the normal range, compiling information about the activity from multiple sources.

6. The method of claim 1, further comprising presenting, to a user, a report that documents activity that falls outside the normal range.

7. The method of claim 6, wherein the report documents events occurring in association with the activity that falls outside the normal range.

8. A computer program product for detecting abnormal activity occurring on a computing system, the computer program product comprising a computer-readable medium having computer-usable program code embodied therein, the computer-usable program code configured to perform the following when executed by at least one processor:
observe, over a period of time, activity occurring on a computing system;
establish, for the computing system based on the observations, a normal range associated with the activity that is observed on the computing system;
monitor the computing system for the activity; and
document the activity on the computing system that falls outside the normal range.

9. The computer program product of claim 8, wherein the computer-usable program code is further configured to notify a user when the activity on the computing system falls outside the normal range.

10. The computer program product of claim 8, wherein observing the activity comprises observing systems logs for the activity.

11. The computer program product of claim 8, wherein the computer-usable program code is further configured to, when activity is detected on the computing system which falls outside the normal range, gather additional information about the activity.

12. The computer program product of claim 8, wherein the computer-usable program code is further configured to, when activity is detected on the computing system which falls outside the normal range, compile information about the activity from multiple sources.

13. The computer program product of claim 8, wherein the computer-usable program code is further configured to present, to a user, a report that documents activity that falls outside the normal range.

14. The computer program product of claim 13, wherein the report documents events occurring in association with the activity that falls outside the normal range.

15. A system for detecting abnormal activity occurring on a computing system, the system comprising:
at least one processor;
at least one memory device coupled to the at least one processor and storing instructions for execution on the at least one processor, the instructions causing the at least one processor to:
observe, over a period of time, activity occurring on a computing system;
establish, for the computing system based on the observations, a normal range associated with the activity that is observed on the computing system;
monitor the computing system for the activity; and
document the activity on the computing system that falls outside the normal range.

16. The system of claim 15, wherein the instructions further cause the at least one processor to notify a user when the activity on the computing system falls outside the normal range.

17. The system of claim 15, wherein observing the activity comprises observing systems logs for the activity.

18. The system of claim 15, wherein the instructions further cause the at least one processor to, when activity is detected on the computing system which falls outside the normal range, gather additional information about the activity.

19. The system of claim 15, wherein the instructions further cause the at least one processor to, when activity is detected on the computing system which falls outside the normal range, compile information about the activity from multiple sources.

20. The system of claim 15, wherein the instructions further cause the at least one processor to present, to a user, a report that documents activity that falls outside the normal range.
